(19) United States
(12) Patent Application Publication
(10) Pub. No.: US 2005/0288817 A1
(43) Pub. Date: Dec. 29, 2005

(54) CHAMBER BASED DISPATCH METHOD

(76) Inventors: Wei Chen, Hsin-Chu Hsien (TW); Chien Hsu, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,568

(22) Filed: Nov. 16, 2004

(30) Foreign Application Priority Data
Jun. 23, 2004 (TW) 093118115

(51) Int. Cl. G06F 7/00

(52) U.S. Cl. 700/213

(57) ABSTRACT

A chamber based dispatch method for dispatching a plurality of wafers to an equipment is disclosed. The equipment has a plurality of chambers for processing the wafers according to a plurality of recipes. The method includes setting states of the equipment and the chambers, determining whether the recipes are executable according to the states of the chambers, and dispatching the wafers to the equipment according to the executable recipes so that the chambers processing the wafers.

### BACKGROUND OF INVENTION

1. Field of the Invention

The present invention relates to a method for dispatching wafers to a semiconductor equipment, and more particularly, to a method for dispatching wafers in accordance with the states of chambers.

2. Description of the Prior Art

In a semiconductor manufacturing process, wafers are dispatched to different semiconductor equipments for processing by different recipes for the desired products. Each equipment has a plurality of chambers, provided with a plurality of recipes for wafer processing. Each recipe has a defined chamber path. The chamber path records chambers used for wafer processing when a recipe is executed in an equipment. Referring to FIG. 1, a schematic diagram for wafer dispatching in a manufacturing process according to the prior art, a plurality of wafers 12, 14 are dispatched into an equipment 20 for processing according to a corresponding recipe. The equipment 20 comprises a plurality of loading ports 22, 24 and a plurality of chambers 26, 28. The loading port 22 connects with the chamber 26, and the loading port 24 connects with the chamber 28. Two recipes corresponding to two chamber paths are defined in the equipment 20, one chamber path leading to the chamber 26, and another chamber path leading to the chamber 28. If the process paths for wafer processing require passing through the chamber 26 or 28, the wafers 12, 14 will be dispatched to the loading port 22 and loading port 24 of the equipment 20. The loading port 22 transfers the wafer 12 into the chamber 26 and the loading port 24 transfers the wafer 14 into the chamber 28. The wafers 12 and 14 can be processed respectively in the chambers 26 and 28 of the equipment 20 to enhance the efficiency of the equipment 20.

When the chamber 26 malfunctions, the wafer 12 already at the loading port 22 cannot be processed in the chamber 26 and must seek another chamber path using the corresponding recipe, that is, the wafer 12 may also be processed in the chamber 28. However, the loading port 22 does not connect with the chamber 28. The wafer 12 waiting at the loading port 22 needs to be taken out and re-transferred to the loading port 24, and, in turn, to the chamber 28 for processing. Although the chambers 26 and 28 are in the same equipment 20, the loading ports are different. Therefore, an extra time is needed for transferring the wafer to be processed, and the wafer processing time is extended. In short, in the conventional wafer dispatching system, a wafer is dispatched to a loading port to wait for processing in a chamber. When the chamber malfunctions and the dispatched wafer can not be processed according to the original chamber path, the wafer dispatched to the loading port needs to be re-dispatched, and the wafer dispatching system cannot be aware of states of the chambers in the equipment. This prolongs the wafer processing time and the efficiency for the system operation is reduced.

### SUMMARY OF INVENTION

Accordingly, an object of the claimed invention is to provide a method for dispatching wafers to an equipment in accordance with the states of chambers therein.

The method according to the claimed invention dispatches wafers to an equipment having a plurality of chambers for processing the wafers according to a plurality of recipes. The method comprises the steps of setting states of the equipment and the chambers, determining whether the recipes are executable according to the states of the chambers, and dispatching the wafers to the equipment according to the executable recipes so that the wafers are processed in the chambers.

When any chamber in any equipment malfunctions, the dispatching system is made aware of the state of the chamber immediately. The chamber path involving the mal-chamber is not executable. Those wafers requiring this chamber path for processing are dispatched in other executable chamber paths for processing according to the corresponding recipe. Therefore, the problem of the conventional dispatching system not being able to dispatch wafers over again is not encountered in the claimed invention. Moreover, the dispatching system is made aware of the states of chambers in real time for full management. Therefore, the claimed invention not only saves time for re-delivering the wafers when the chambers malfunction, but also increases the efficiency of the system.

These and other objects of the invention will no doubt become obvious to those of ordinary skill in the art after reading the following detailed description of the preferred embodiment is illustrated figures and drawings.

### BRIEF DESCRIPTION OF DRAWINGS

FIG. 1 is a schematic diagram for wafer dispatching in a manufacturing process according to the prior art.

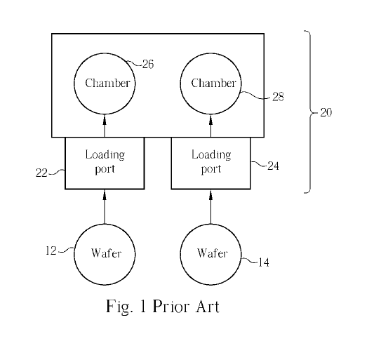

FIG. 2 is a schematic diagram for wafer dispatching in a manufacturing process according to the present invention.

FIG. 3 is a flow chart for setting the semiconductor equipment according to the method of the present invention.

FIG. 4 is a flow chart for wafer dispatching according to the present invention.

FIG. 5 is a schematic diagram for wafer dispatching in one embodiment according to the present invention.

FIG. 6 is a schematic diagram showing the recipe of wafer processing for wafers shown in FIG. 5.

FIG. 7 is a flow chart for the manual management of the equipment in one embodiment of the present invention.

### DETAILED DESCRIPTION

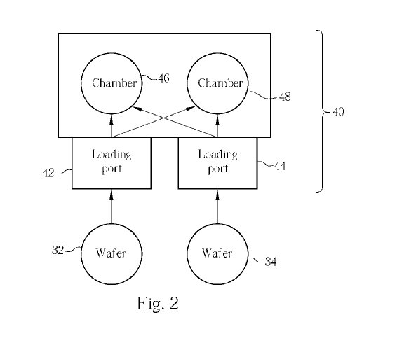

Please refer to FIG. 2 showing a schematic diagram for wafer dispatching in a manufacturing process according to the present invention. A plurality of wafers 32, 34 are dispatched to an equipment 40 for wafer processing according to the recipe. The equipment 40 comprises a plurality of loading ports 42, 44, and a plurality of chambers 46, 48. The loading port 42 connects with the chamber 46 and the chamber 48, and the loading port 44 connects with the chamber 46 and the chamber 48. Two recipes corresponding to two chamber paths are defined in the equipment 40, one chamber path leading to the chamber 46 and the other chamber path leading to the chamber 48. In case that the wafer 32 and the wafer 34 both need to be processed in the chamber 46 and the chamber 48, they can be dispatched into the loading port 42 and the loading port 44, respectively, and the loading port 42 will transfer the wafer 32 into the chamber 46 for wafer processing and the loading port 44 will transfer the wafer 34 into the chamber 48 for wafer processing. Therefore, the chambers 46 and 48 can be used to perform the wafer processing for the wafers 32 and 34 respectively at the same time, and the efficiency of the equipment 40 is enhanced.

When the chamber 46 malfunctions, the wafer 32, originally set to be processed in the chamber 46, can find another chamber path in the corresponding recipe. For example, the wafer 32 can be also processed in the chamber 48.

The present invention is further described in the preferred embodiment as follows.

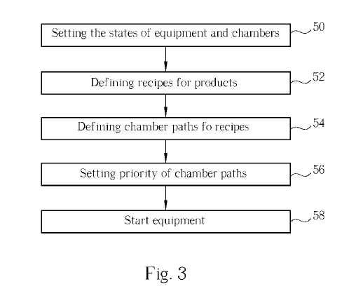

For increasing the efficiency of the wafer dispatching and the semiconductor equipment 40 management, the equipment 40 and chamber 46, 48 have to be preset in the dispatching system, and then, the wafers 32, 34 are dispatched according to the recipe. Please refer to FIG. 3. FIG. 3 is a flow chart showing steps to set the semiconductor equipment 40 according to the present invention as follows.

Step 50: setting the states of the equipment 40 and chambers 46 and 48 as “standby”, “in production”, or “malfunction”. “Standby” indicates the chamber can accept wafers for processing. “In production” indicates the chamber has wafers therein for processing. “Malfunction” indicates the chamber cannot accept wafers for processing.

Step 52: defining a recipe to execute according to the product each wafer is to be manufactured to.

Step 54: defining a chamber path for each recipe. Each chamber path records the chambers able to be used to process the wafers when the equipment 40 executes the recipe. The chamber path is expressed by operators including “AND” and “OR”. “AND” indicates that two chambers corresponding to both sides of the operator must be used for processing the wafer. “OR” indicates that either of two chambers corresponding to both sides of the operator can be used for processing the wafer. For example, a chamber path expressed as “46 AND 48” indicates that both of two chambers 46, 48 must be used. A chamber path expressed as “46 OR 48” indicates that one of two chambers 46, 48 is used.

Step 56: setting the priority of the chamber path for each recipe; and

Step 58: starting the equipment 40.

Before equipments execute recipes, the priority of the chamber path for each recipe is decided. The priority depends on the states of chambers 46, 48 and product varieties. The wafer corresponding to a chamber path with a high priority will be dispatched to chambers 46, 48 for processing prior to the wafer with a low priority. For example, if the state of chamber 46 is “malfunction”, all of the chamber paths having to use the chamber 46 will be decided as “not executable”, and, accordingly, the priority of these chamber paths are decided as the lowest. In addition, some products are classified as high priority due to the necessity of the production line. In this situation, the priority of the chamber paths of the recipe needed in the production is raised for accelerating the process of the wafers to manufacture the products.

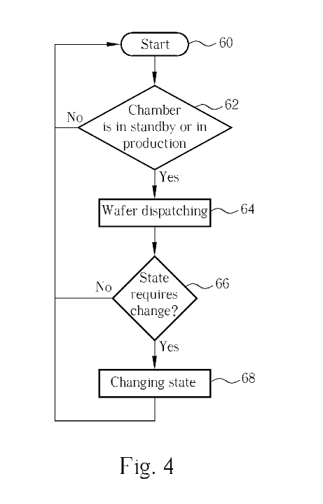

After the equipment 40 is started, the wafers 32, 34 are dispatched to the equipment 40 for wafer processing, according to the dispatching method of the present invention. Referring to FIG. 4, a flow chart of the wafer dispatching method of the present invention is shown and comprises the steps of:

Step 60: the dispatching system starting to dispatch wafers 32, 34.

Step 62: deciding the states of the chambers 46, 48 in the chamber path corresponding to the wafers 32, 34 as “standby” or “in production”. If the states of the chambers 46, 48 are “standby” or “in production”, then step 64 proceeds. If the states of the chambers 46, 48 are not “standby” or “in production”, that is, the state is “malfunction”, it indicates that the wafer processing can not proceed and the wafers 32, 34 will not be dispatched to the equipment 40 and will return to step 60 to use another executable chamber path for dispatching.

Step 64: dispatching the wafers 32, 34 to the equipment 40 according to the priority of the chambers 46, 48 to facilitate the process of the wafers 32, 34 in the chambers 46, 48 in the equipment 40.

Step 66: determining the states of the equipment 40 and the chambers 46, 48. If the states require changing, then step 68 proceeds. If the states do not require changing, then step 60 proceeds to dispatch a next wafer for processing. For example, after the wafer 32 or 34 is delivered to the chamber 46 or 48, for preventing from repeating delivering the wafer 32 or 34 to the chamber 46 or 48 where the wafer is ever processed, or when the priority of the chamber path is required to adjust, the original state, “standby”, must be changed to “in production”. Furthermore, if the chamber 46 or 48 is continuously used to process two batches of wafers, the state of the chamber 46 or 48 will sustain at “in production” after the first batch of wafers are processed and when the next batch of wafers are processed.

Step 68: changing the states of the equipment 40 and the chambers 46, 48 to “standby”, “in production”, or “malfunction”. The state of the equipment 40 can be automatically changed according to the states of the chambers 46, 48.

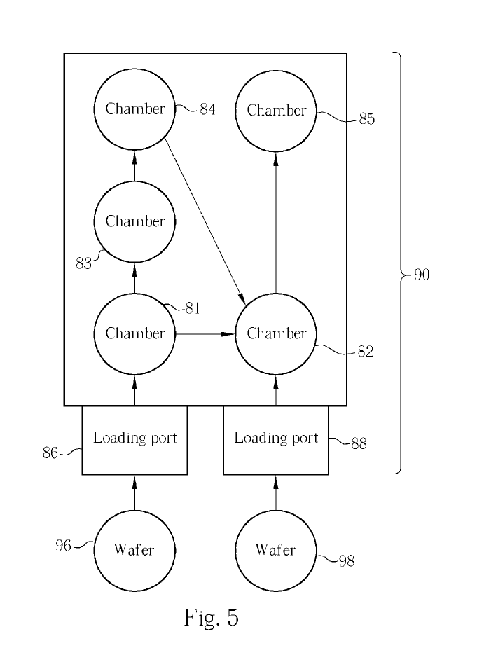

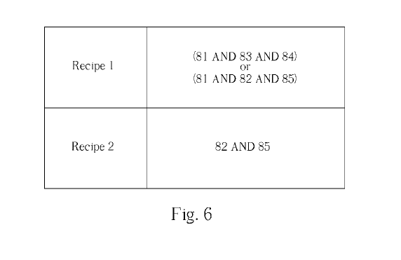

For more detailed description of the dispatching method of the present invention, please refer to FIG. 5 for explanation of the mechanism of wafer dispatching according to the states of equipments and chambers and the recipe. FIG. 5 is a schematic diagram showing a framework of wafer dispatching. An equipment 90 comprises a plurality of loading port 86, 88 and a plurality of chambers 81, 82, 83, 84, 85, the loading port 86 connecting with the chamber 81, and the loading port 88 connecting with the chamber 82. Wafers 96, 98 can be delivered to the chambers 81, 82, 83, 84, 85 through the loading ports 86, 88 respectively for processing. Similar to the equipment 40 shown in FIG. 2, a plurality of recipes are defined in the equipment 90 to record the chamber paths required when the wafers 96, 98 are processed therein. Please refer to FIG. 6 showing a schematic diagram of recipes for wafers 96, 98. Recipe 1 is for the wafer 96 and gives a definition of a chamber path expressed by operators as follows: (81 AND 83 AND 84) OR (81 AND 82 AND 85), that is, the wafer 96 must be processed in the chambers 81, 83, 84 in order or be processed in the chambers 81, 82, 85 in order. Recipe 2 is for the wafer 98 and gives a definition of a chamber path expressed by operators as follows: (82 AND 85), that is, the wafer 98 must be processed in the chambers 82 and 85.

The chamber 82 may accept the wafer 98 delivered from the loading port 88 while the wafer 96 is processed in chambers 81, 84. In case that all the chambers 81-85 of the equipment 90 are in the “standby” state, and after the processes for the wafer 96 according to the chamber path of (81 AND 83 AND 84) and for the wafer 98 according to the chamber path of (82 AND 85) begin, if the chamber path (81 AND 83 AND 84) is not executable due to the malfunction of the chamber 83, the equipment 90 will execute another executable chamber path (81 AND 82 AND 85) to replace the original chamber path (81 AND 83 AND 84). Thus, when the chamber 83 malfunctions and the chamber path (81 AND 83 AND 84) is not executable, the equipment 90 will change the setting of the chamber path (81 AND 83 AND 84) for the wafer 96 to enter into the chamber path (81 AND 82 AND 85) to complete the related process in the recipe 1.

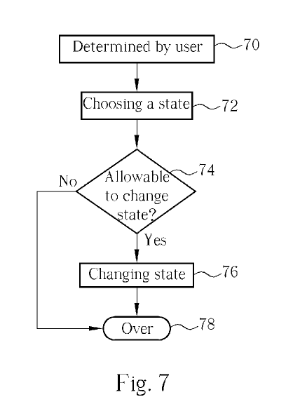

In the management for the equipment 40 and the chambers 46, 48 as shown in FIG. 2, some special situations require handling by hand. For example, when part of the chambers 46, 48 requires maintenance, the operation of the chamber 46, 48 requires interrupting by hand, and, in the same time, the states of the chamber 46, 48 in the maintenance must be changed into ‘malfunction’ for preventing the wafers from delivery to the chamber 46, 48. Please refer to FIGS. 2 and 7, FIG. 7 shows a flow chart of the manual management of equipment. The flow chart comprises the steps as follows:

Step 70: the user determines whether if the states of the equipment 40 and the chambers 46, 48 require changing.

Step 72: the user chooses the states required for the equipment 40 and the chambers 46, 48.

Step 74: the user determines whether if the states of the equipment 40 and the chambers 46, 48 can be changed before changing, to ensure that the change won't affect the other chambers' operation. If the change is allowable, the step 76 proceeds. If the change is not allowable, the step 78 proceeds.

Step 76: the user changes the states to the selected ones as required for the equipment 40 and the chambers 46, 48.

Step 78: the user finishes the manual management of equipment.

Compared to that in conventional techniques, the wafer dispatching is performed according to the states of the equipments and the chambers in the chamber based dispatch method of the present invention. When any chamber in any equipment malfunctions, the dispatching system is made aware of the state of the chamber immediately, so that the chamber path involving the malfunctioned chamber is not executable. Those wafers originally requiring the chamber path for processing find another executable chamber path according to the corresponding recipe, or follow the same chamber path but are dispatched to another normal chamber through the dispatching system. The problem encountered in conventional techniques that wafer delivery must stop and go back to the beginning once more is resolved. Furthermore, the states of the chamber can be known immediately for more complete management. Therefore, the present invention saves the time originally required for re-delivering wafers when the chambers malfunction, thus the whole efficiency of the system is enhanced.

1. A method for dispatching wafers to an equipment having a plurality of chambers for processing the wafers according to a plurality of recipes, the method comprising:
setting states of the equipment and the chambers;
determining whether the recipes are executable according to the states of the chambers; and
dispatching the wafers to the equipment according to the executable recipes so that the wafers are processed in the chambers.

2. The method of claim 1, further comprising:
defining a chamber path for each of the recipes, wherein the chamber path records the chambers used to process the wafers when the equipment executes each of the recipes.

3. The method of claim 2, wherein the chamber path is expressed by a plurality of operators.

4. The method of claim 3, wherein the operators comprise AND and/or OR operators.

5. The method of claim 2, further comprising:
setting the priority of the chamber path; and
dispatching the wafers to the chambers according to the priority of the chamber path.

6. The method of claim 5, further comprising:
defining categories of products, and setting at least one recipe necessarily executed for each category; and
setting the priority of the chamber path corresponding to the recipes according to the category of the wafers.

7. The method of claim 5, wherein the priority of the chamber path is determined according to the states of the chambers.

8. The method of claim 1, wherein the states of the equipment and the chambers comprise standby, production, and malfunction.

9. The method of claim 1, wherein the states of the equipment automatically change in accordance with the states of the chambers.

10. A method for dispatching wafers to an equipment having a plurality of chambers for processing the wafers, the method comprising:
setting states of the equipment and the chambers;
defining categories of products, and setting at least one recipe necessarily executed for each category;
defining a chamber path for each of the recipes, wherein the chamber path records the chambers used to process the wafers when the equipment executes each of the recipes;
setting the priority of the chamber path corresponding to the recipes according to the category of the wafers;
determining whether the recipes are executable according to the states of the chambers; and
dispatching the wafers to the equipment according to the executable recipes so that the wafers are processed in the chambers.

11. The method of claim 10, wherein the chamber path is expressed by a plurality of operators.

12. The method of claim 11, wherein the operators comprise AND and/or OR operators.

13. The method of claim 10, wherein the priority of the chamber path is determined according to the states of the chambers.

14. The method of claim 10, wherein the states of the equipment and the chambers comprise standby, in production, and malfunction.

15. The method of claim 10, wherein the states of the equipment automatically change in accordance with the states of the chambers.
